(19) United States
(12) Patent Application Publication
(10) Pub. No.: US 2008/0152183 A1
(43) Pub. Date: Jun. 26, 2008

(54) Compact wireless headset

(76) Inventors: Craig Janik, Palo Altos, CA (US); Robert Francis Young, Santa Cruz, CA (US)

Correspondence Address: DLA PIPER US LLP, 2000 UNIVERSITY AVENUE, E. PALO ALTO, CA, 94303-2248, US

(21) Appl. No.: 11/973,708

(22) Filed: Oct. 9, 2007

Related U.S. Application Data
(60) Provisional application No. 60/850,858, filed on Oct. 10, 2006.

(51) Int. Cl. H04R 25/02

(52) U.S. Cl. 381/375

(57) ABSTRACT

A method, system, and apparatus for an improved wireless headset configuration is provided. The apparatus is an open-air headset, which includes an ear attachment, a transceiver, a speaker, and a microprocessor. The headset further includes a directional microphone having a sensitivity field such that the sensitivity field is mutually exclusive from a non-sensitivity field, and is configured such that the speaker is placed in a region within the non-sensitivity field. The system further includes an audio gateway device, whereas the method includes the steps of transmitting a signal from an audio gateway device to the open-air wireless headset and receiving a signal from the headset into the audio gateway device.

This application claims the benefit of U.S. Provisional Application No. 60/850,858 filed Oct. 10, 2006.

### FIELD OF THE INVENTION

The present invention relates to the field of wireless audio headsets that are used in conjunction with mobile cellular phones, personal computers, and other audio gateway devices.

### BACKGROUND OF THE INVENTION

Bluetooth®, invented by Ericsson (Stochholm, Sweden), is a short-range, open wireless communications standard that includes different transmission modes and can simultaneously accommodate several different types of devices. Bluetooth is often referred to as a PAN (Personal Area Network). Most relevant to this disclosure is Bluetooth's ability to carry real time voice data via a SCO (Synchronous Connection Oriented) link. An SCO link is a digital transmission mode where voice packets transmitted back and forth between an audio gateway (e.g. a mobile cellular phone) and a headset are sent based on a clock common to both devices. Packets that are not received by one of either the headset or audio gateway are not retransmitted. The Bluetooth specification is based on frequency-hopping spread spectrum technology and is also known as IEEE 802.15.1, which is hereby incorporated by reference. The Bluetooth protocol also includes device profiles, which define the capabilities of various types of devices. For example, the Headset Profile defines the interactions between headsets and audio gateways. The Handsfree Profile defines the interactions between headsets and handsfree systems in automobiles, and audio gateways. The Bluetooth specification in its entirety is available for download at www.bluetooth.org.

Wireless headsets using the Bluetooth communications protocol are convenient and their usage is growing. The headsets attach to the user's ear, allowing the user to communicate via phone without holding the phone up to the user's ear, and also without the constraint of a wire running from the headset to the phone. This affords new use scenarios. For example, because there is no wire, a user may leave the phone in their pocket, briefcase, or purse. When the phone rings, if the user is wearing the headset, they may answer the call on the headset using the answer button on the phone.

The criteria that make up a good headset include comfort, stability on the ear, good sound, and an acceptable shape. This last characteristic may be the most subjective criterion, but in the end it may be the most important. There has been resistance to wireless headsets that conjure up images of science fiction television shows with large earpieces hanging off of or out of peoples' ears. For example, Rob Walker, in an article entitled Headgear, in the Jul. 16, 2006 issue of the New York Times Magazine, wrote, “One contributor to the tech-focused Web site Slashdot expressed it memorably: “Of all the things to come to pass from the original ‘Star Trek,’ I never in my wildest dreams figured we'd all look like Lt. Uhura with these things hanging out of our ears,” this person wrote, advising headset users that “you look stupid” . . . Scott Martin, who oversees global marketing of these devices for Motorola, acknowledges that there has been a certain resistance among some consumers that's attributable to this “Star Trek” issue . . . ”.

There are many wireless headsets on the market, but the majority of headsets on the market fit into two basic designs. One such design is provided in FIG. 1 which shows the BT250 headset 1 sold under the Jabra brand and manufactured by GN, of Denmark. The BT250 headset 1 is an example of a pod-shaped design, which includes a large curved pod 2 that is placed behind the ear. The pod 2 encloses the electronics components, battery, and controls, such as the answer button 3. A curved speaker extension 5 holds the speaker near the ear canal, and a microphone boom 4 extending from the bottom of the pod 2 holds the microphone nearer to the wearer's mouth. The microphone is located at the end the of microphone boom 4. There is a signal-to-noise advantage to holding the microphone closer to the wearer's mouth.

Another popular headset design is the boom-shaped design shown in FIG. 2, which is the Discovery 610 headset 6 sold by Plantronics, Inc. of Santa Cruz, Calif. As illustrated, Discovery 610 headset 6 includes a boom-shaped headset 7, which further includes a microphone port 8 and an ear canal extension 9. The purpose of the boom shape is again to provide an appendage to hold microphone port 8 closer to the wearer's mouth, wherein microphone port 8 is located at the tip of boom-shaped headset 7, as shown.

Another constraint on the design of headsets is that the output from the speaker must be acoustically isolated from the microphone. If sound from the speaker, i.e., the far side caller's voice, enters the microphone, it will feedback through the communications system, resulting in an echo heard by the far side caller. Placing the microphone at the end of a boom helps to alleviate far side echo by increasing the distance between the microphone and the speaker.

Another approach to preventing far side echo is to channel the speaker output through an appendage that extends into the ear canal. The appendage is typically sized so that it fills a substantial portion of the ear canal, thereby providing an acoustic seal. Many headsets found on the market incorporate both the boom design and an ear canal speaker channel, for example referring again to the Discovery 610 headset 6 shown in FIG. 2.

However, user reviews of headsets that extend into the ear canal show that many users find this design to cause discomfort.

Virtually all headsets are ambidextrous, that is, they can be worn on either the right or left ear with some minor adjustments. The boom-shaped designs are typically symmetrical about the axis of the main body of the headset. The pod-shaped designs typically have a sound channel that aims the sound from the speaker, and that is rotatable to point toward the ear depending on what side the headset is worn.

The need to place the microphone closer to the user's mouth causes all existing headsets to include some microphone boom extension form factor to place the microphone closer to the user's mouth. Thus, the majority of headsets currently available share this form factor.

The problem with the boom form factor is that due to the way the form extends along the side of a wearer's face, it calls attention to itself. Users know that they look strange because they see others wearing headsets and always notice them. Because headsets are so prominent when they are worn, they are like an item of apparel. But there is no other item of apparel in our culture that extends so far into the user's face. Many consumers will not wear a headset with such formal attributes for reasons of personal taste. The extension of the boom across the user's face also makes the boom-shaped designs problematic when worn during various activities where the user's arms might strike the headset.

Another problem with the boom is that it distributes a portion of the weight of the headset away from the attachment point on the ear. When the wearer moves their head, inertial forces act on the boom mass, and the boom and the headset can start to move independently from the head.

What is required is a headset that is boomless, compact, and that is open-air, that is, it does not extend into the wearer's ear canal. The lack of a boom form factor makes the shape more acceptable to a wider range of consumers as an item of apparel, whereas the boomless, compact form allows the center of mass of the headset to be very close to the attachment point at the wearer's ear. This boomless design must be achieved all the while allowing for good acoustics and ambidexterity.

### SUMMARY OF THE INVENTION

The present invention solves the aforementioned problems by providing a method, system, and apparatus for an improved wireless headset configuration.

In one embodiment, an open-air wireless headset is provided. Within such embodiment, the headset includes an ear attachment, a transceiver, a speaker, and a microprocessor. This embodiment further includes a directional microphone having a sensitivity field such that the sensitivity field is mutually exclusive from a non-sensitivity field, and configured such that the speaker is placed in a region within the non-sensitivity field.

In another embodiment, an open-air wireless headset is also provided. Within such embodiment, the headset includes an ear attachment, a transceiver, a speaker, a microprocessor, and a bi-directional microphone having a first sensitivity field, a second sensitivity field, and a non-sensitivity field. For this embodiment, the first sensitivity field, second sensitivity field, and non-sensitivity field are each mutually exclusive from each other, and the headset is configured such that the speaker is placed in a region within the non-sensitivity field.

In a further embodiment, another open-air wireless headset is provided. Within such embodiment, the headset includes an ear hook, a transceiver, a speaker, and a microprocessor having a digital signal processor (DSP). For this embodiment, the headset also includes a directional microphone having a sensitivity field such that the sensitivity field is mutually exclusive from a non-sensitivity field, and configured such that the speaker is placed in a region within the non-sensitivity field.

A method for routing a wireless signal is also provided. This embodiment includes the steps of transmitting a signal from an audio gateway device to an open-air wireless headset and receiving a signal from the headset into the audio gateway device. Within this embodiment, the headset includes an ear attachment, a transceiver, a speaker, and a microprocessor. For this embodiment, the headset also includes a directional microphone having a sensitivity field such that the sensitivity field is mutually exclusive from a non-sensitivity field, and configured such that the speaker is placed in a region within the non-sensitivity field.

A system for routing a wireless signal is also provided, which includes an audio gateway device and an open-air headset. Within this embodiment, the headset includes an ear attachment, a transceiver, a speaker, and a microprocessor. For this embodiment, the headset also includes a directional microphone having a sensitivity field such that the sensitivity field is mutually exclusive from a non-sensitivity field, and configured such that the speaker is placed in a region within the non-sensitivity field.

Other objects and features of the present invention will become apparent by a review of the specification, claims and appended figures.

### BRIEF DESCRIPTION OF THE DRAWINGS

FIG. 1 shows a Jabra brand pod-shaped headset.

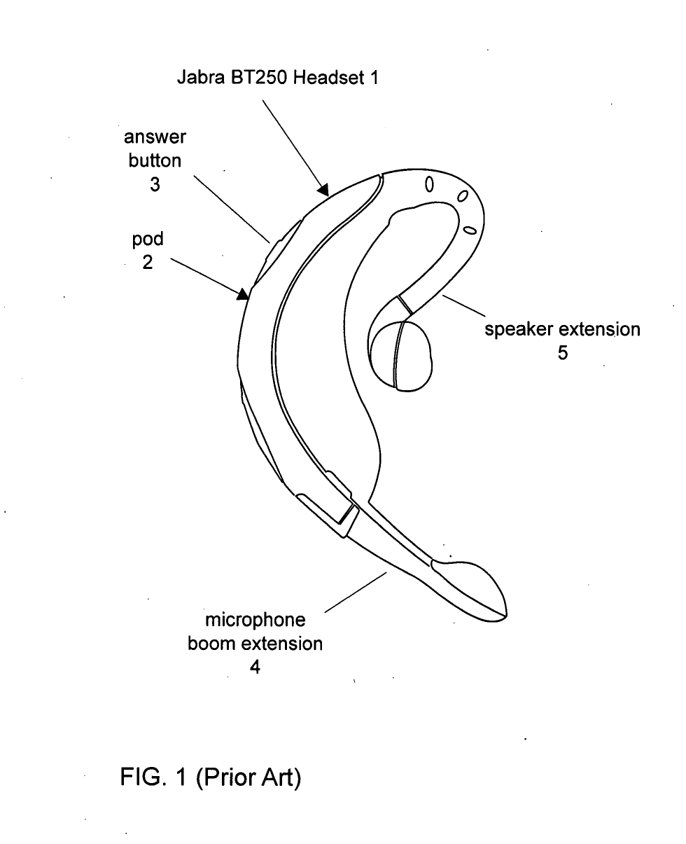

FIG. 2 shows a boom-style wireless headset with an ear canal appendage.

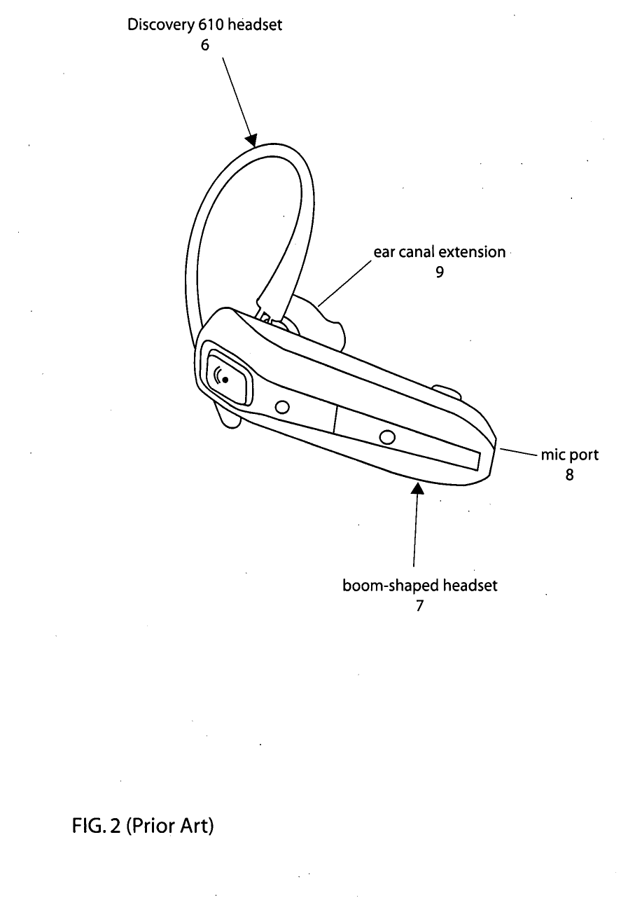

FIG. 3 shows a compact wireless headset.

FIG. 4 shows a wireless headset with a view of the volume button.

FIG. 5 shows a wireless headset with a view of the microphone port.

FIG. 6 shows an orthographic view of a headset with the cover removed.

FIG. 7 shows a view of the partially assembled inner cover.

FIG. 8 is an exploded assembly view of the headset.

FIG. 9 shows a view of the charging port side of the headset.

FIG. 10 shows a view of the cover and ear hook assembly and its attachment means.

FIG. 11 shows an assembly detail of right ear hook assembly.

FIG. 12 shows a side view of the wearing position of the headset and sensitivity fields.

FIG. 13 shows a view of the headset worn on the left side.

### DETAILED DESCRIPTION OF THE PREFERRED EMBODIMENTS

Unless otherwise indicated, all terms used herein have the same meaning as they would to one skilled in the art. The following terms are used frequently to define the invention, denote key concepts and are intended to be defined as indicated below.

A wireless headset (hereafter headset) is defined as a wearable audio communication device that includes a speaker, a microphone, a wireless transmission system (which includes a transceiver), and a battery, that can both receive an audio transmission and play the transmission for the wearer, and send the wearer's voice as an audio transmission. A headset includes controls for answering and ending calls, and for adjusting the volume of the audio.

An audio gateway is a device that routes an audio transmission from one communications system, to a wireless transmission system. For example, a mobile cellular phone is an audio gateway that routes audio transmissions from the mobile cellular network to a headset or to a handsfree system. A PC with a Bluetooth wireless transmission system is an audio gateway that routes voice packets from an IP network, such as a local area network or the Internet, to a headset.

A speaker is a speaker (sound output transducer) that is placed near a user's ear, and converts electrical signals to sound waves.

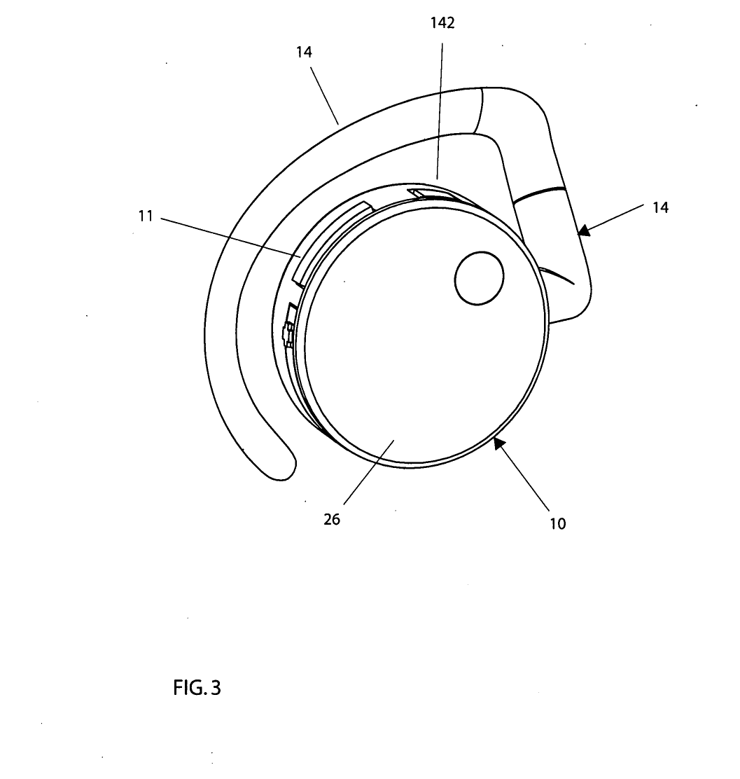

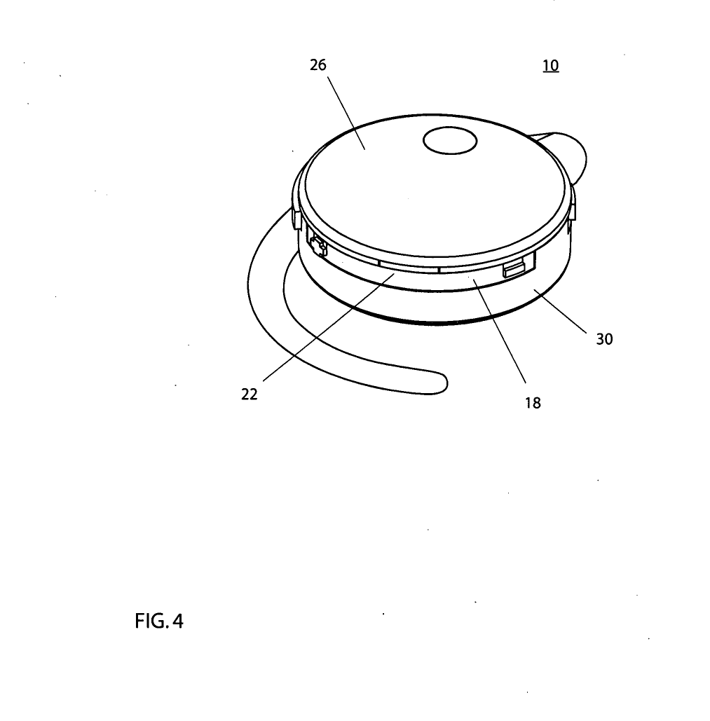

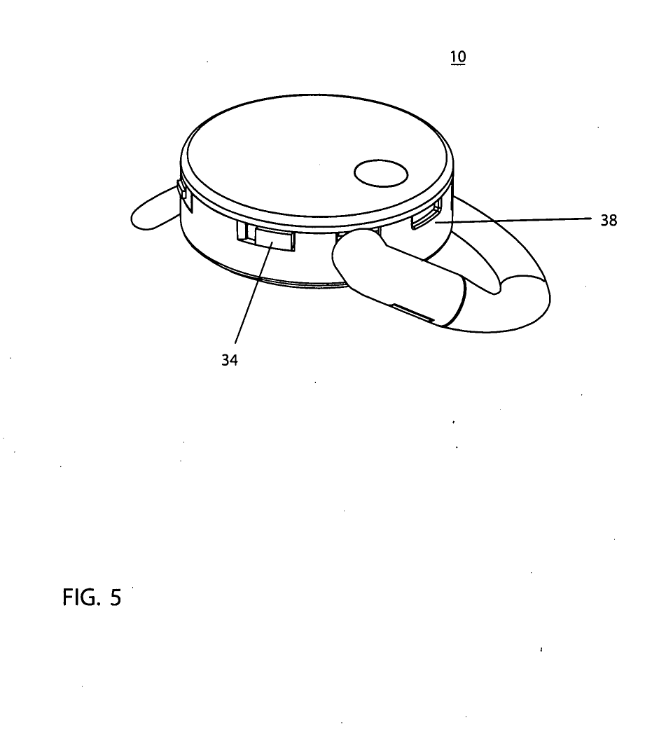

In FIGS. 3-5, several exterior views of a wireless headset according to a preferred embodiment of the present invention are provided. As illustrated in FIG. 3, for example, headset 10 preferably includes outer cover 26, answer button 11, ear hook plug 142, and is coupled to ear hook assembly 14. In FIG. 4, a different view is provided, which shows that headset 10 preferably further includes inner cover 30, volume button 18, and light pipe 22. In FIG. 5, yet another view is provided to show that headset 10 preferably also includes microphone port 38, as well as power button 34. In a preferred embodiment, it should be appreciated that each of outer cover 26, inner cover 30, answer button 11, ear hook assembly 14, sliding power button 34, and volume button 18 are manufactured out of injection-molded PC-ABS plastic.

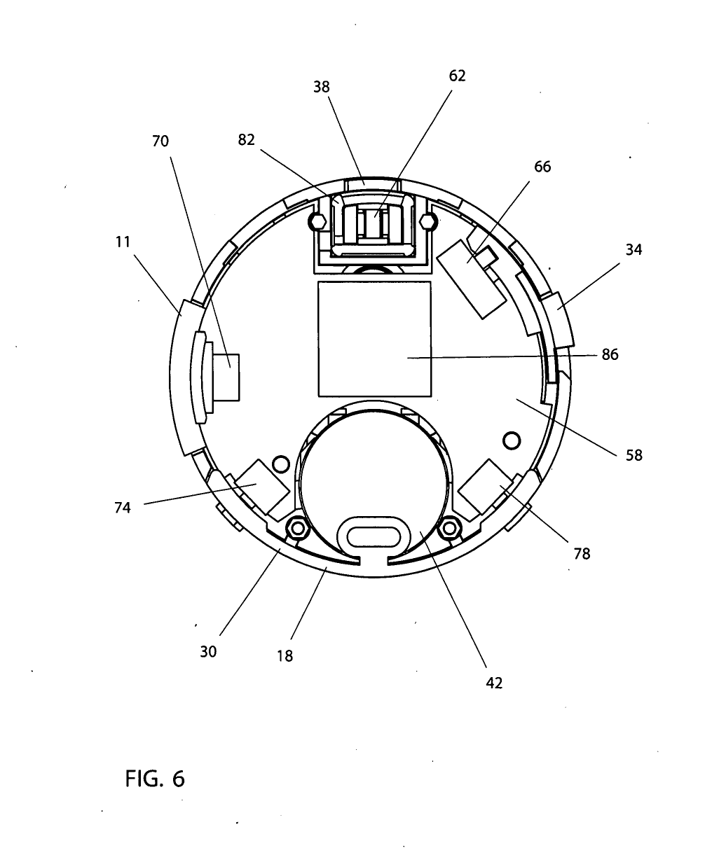

In FIGS. 6-11, several interior views of a wireless headset according to a preferred embodiment of the present invention are provided. FIG. 6, for example, shows an orthographic view of headset 10 with outer cover 26 removed. As illustrated, headset 10 preferably further includes microphone 62 and microphone boot 82 coupled to microphone port 38, as shown, wherein microphone port 38 is an opening that enables external sound waves to reach microphone 62. As is also illustrated, headset 10 preferably further includes speaker 42, as well as power switch 66 coupled to power button 34, microprocessor 86 coupled to printed circuit board (PCB) 58, momentary volume up and down switches 74 and 78 coupled to volume control 18, and momentary answer switch 70 coupled to answer button 11, as shown. Here, it should be appreciated that a number of other electronic components such as a battery charging integrated circuit (hereafter IC), a voltage regulator IC, a microphone bias voltage regulator IC, an antenna chip, and various passive components that are associated with a Bluetooth headset, have been omitted for the sake of clarity.

In a preferred embodiment, speaker 42 measures approximately 13 mm in diameter, is 2.5 mm thick, and has an impedance of 32 ohms. Meanwhile, PCB 58 functionally connects answer switch 70, sliding power switch 66, volume up switch 74 and volume down switch 78, microphone 62, and speaker 42 to microprocessor 86, wherein microprocessor 86 is preferably a Bluetooth single chip microprocessor, part number BC358239A, manufactured by Cambridge Silicon Radio (CSR), of Cambridge, England.

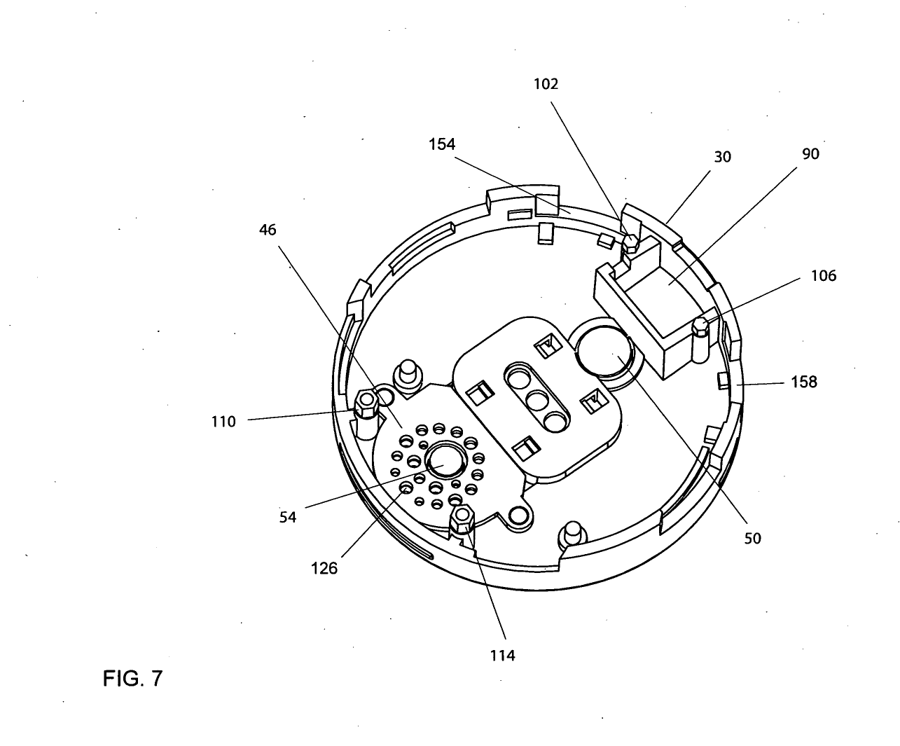

Microphone 62 is preferably located in an elastomeric microphone boot 82 that is injection-molded out of a thermoplastic elastomer measuring Shore A sixty on the hardness scale. The thermoplastic elastomer is preferably Santoprene, manufactured by Monsanto of St. Louis, Mo. The purpose of microphone boot 82 is to isolate microphone 62 from the mechanical vibrations imparted to the headset enclosure, and to help to seal microphone 62 from audio emanating from speaker 42 inside the enclosure. Microphone 62 preferably measures 4 mm in diameter, is 1.5 mm thick, and is a bi-directional noice-cancelling microphone with a nominal sensitivity of −42 dB @ 1 khz. Such a microphone 62 is available from Ole Wolff International, Inc., of Befordshire, England. Microphone boot 82 preferably includes molded-in features that retain microphone 62 in the correct orientation, which are shown in FIG. 6. Microphone boot 82 is preferably located in a microphone chamber 90 (shown in FIG. 7) integral to inner cover 30. Two stranded wire leads (not shown) from the microphone 62 are also preferably soldered to PCB 58.

In FIG. 7, an internal view showing a partially assembled inner cover 30 is provided. As illustrated, headset 10 further includes left and right ear hook cavities 154 and 158. Also, in order to accommodate for speaker 42, speaker plate 46 is provided, which includes speaker port holes 126 and speaker magnet 54, as well as pins 110 and 114. Similarly, in order to accommodate for microphone 62, microphone chamber 90 and microphone magnet 50, as well as pins 102 and 106, are provided.

Speaker plate 46 is preferably a carbon steel nickel-plated speaker plate and is heat-staked on the inside of inner cover 30. Speaker plate 46 and inner cover 30 both have speaker port holes 126 that align so that sound from speaker 42 is ported out of the headset enclosure, as shown. Speaker 42 also preferably includes an adhesive ring that fastens speaker 42 to speaker plate 46.

It should also be appreciate that a speaker-side neodymium magnet 54, as well as a microphone-side neodymium magnet 50, are preferably glued onto a circular cavity in inner cover 30. It should be further appreciated that microphone-side magnet 50 and speaker-side magnet 54 in combination with speaker plate 46 are preferably part of a magnetic coupling attachment system that is used to attach headset 10 to a variety of charging docks.

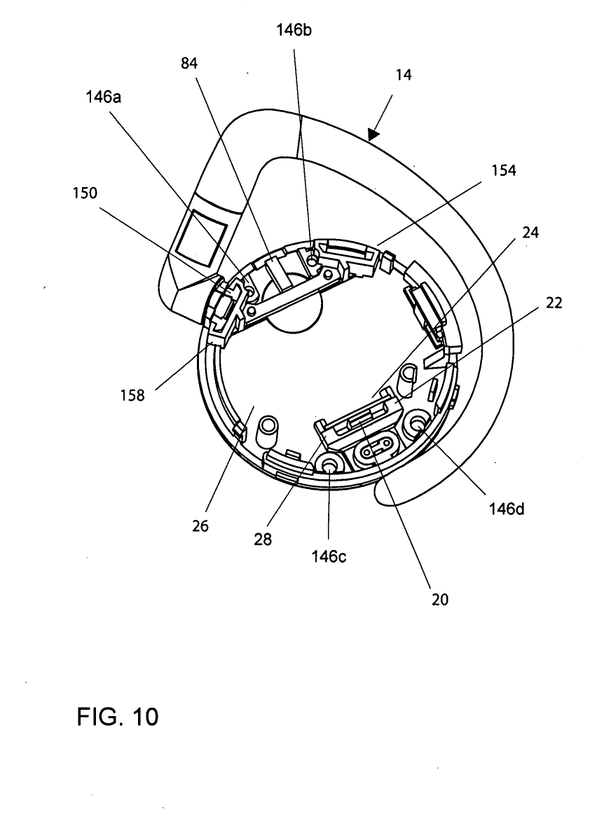

In a preferred embodiment, microphone-side interference pin A 102, microphone-side interference pin B 106, speaker-side interference pin A 110, and speaker-side interference pin B 114, are each slightly oversized and are pressed into corresponding cover bosses 146 (shown in FIG. 10) in outer cover 26, so as to fasten outer cover 26 to inner cover 30. An adhesive is preferably applied to these interference pins during final assembly so that the wireless headset enclosure is permanently and reliably fastened together.

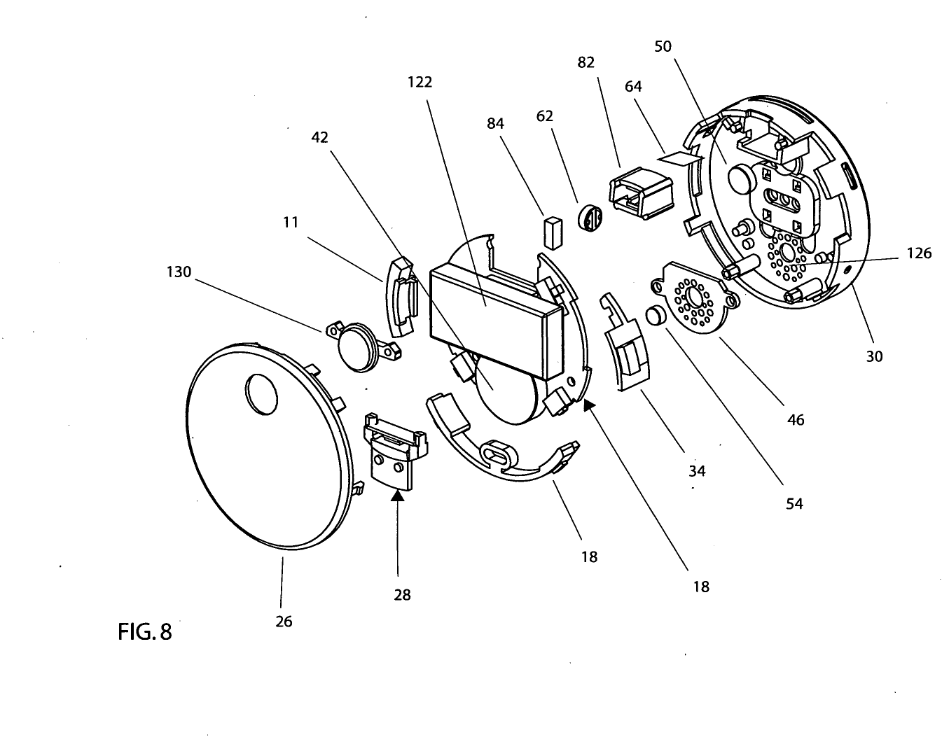

In FIG. 8, an exploded assembly view of a preferred embodiment of headset 10 is provided, which shows several of the aforementioned features of headset 10 in addition to moisture barrier 64, microphone septum 84, insert 130, and battery 122 (preferably a rechargeable lithium ion polymer battery). In a preferred embodiment, moisture barrier 64 is inserted between microphone boot 82 and inner cover 30 so that it covers microphone port 38. Moisture barrier 64 prevents water and dust from entering microphone port 38 with minimal acoustic impedance. Moisture barrier 64 is preferably made of a Saatitech Acoustex 045 Hyphobe thin woven fabric, manufactured by Saatitech of Veniano, Italy.

In a preferred embodiment microphone septum 84 is a die-cut piece of Poron closed-cell foam, manufactured by Rogers Corporation of Rogers, Conn. Microphone septum 84 is preferably adhered to the inside surface of outer cover 26 and shaped so that it conformably seals against microphone 62. Microphone septum 84 sealing against microphone 62 seated in microphone boot 82 acts to bifurcate microphone chamber 90, thereby increasing the isolation of the two sides of microphone 62 ported to the outside of headset 10.

In a preferred embodiment, insert 130 is a die cast aluminum part that has a fine-grained finish. The reflectivity of the insert 130 is preferably designed so as to help the user see headset 10 in low light conditions, such as when it is used in a car at night. In other embodiments, however, a reflective insert 130 could be omitted and/or other decorative elements could be included as part of outer cover 26 including metal inlays, hot-stamped foil and color applications, and paint.

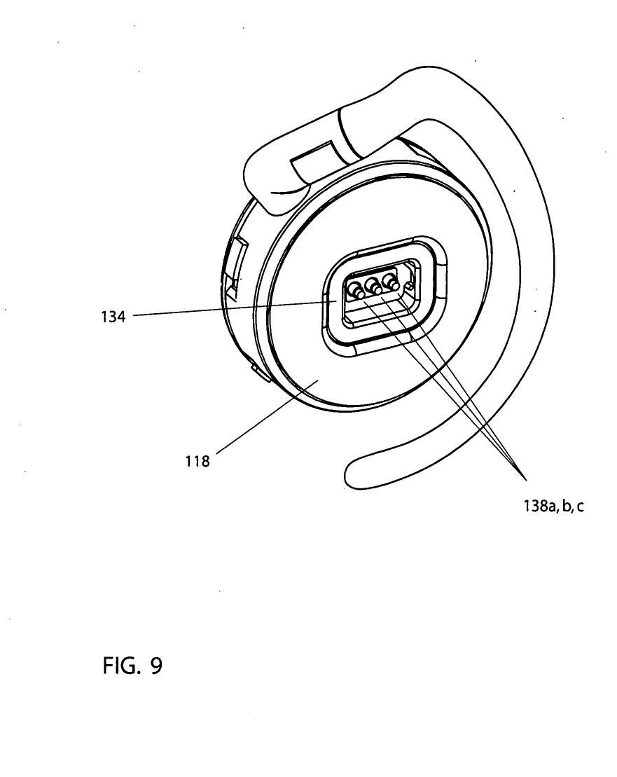

In FIG. 9, a view of the charging port side of headset 10 is provided. As illustrated, headset 10 also preferably further includes comfort cover 118, charging port 134, and spring pins 138a, 138b, and 138c. In a preferred embodiment, it should be appreciated that comfort cover 118 and a charge port 134 are each manufactured out of injection-molded PC-ABS plastic. Also, with respect to pins 138a-c, it should be further appreciated that these pins are preferably gold-plated, spring-loaded metal pins. Charging port 134 is preferably a cavity that allows the three spring-loaded pins 138a-c to be recessed (e.g., a spring pin A 138a, a signal pin C 138c, and a spring pin B 138b). Spring pins 138a-c make electrical contact with three corresponding contact pads on a variety of charging docks designed to work with headset 10, wherein spring-loaded pins 138a-c are preferably soldered directly to PCB 58.

In FIG. 10, an internal view of outer cover 26 and ear hook assembly 14 (here a right ear hook is shown) is provided, wherein outer cover 26 includes a molded-in right ear hook attach cavity 158 and left ear hook attach cavity 154. As illustrated, outer cover 26 is preferably coupled to cover bosses 146a-d and preferably attaches to hook assembly 14 via attach clip 150 (here attach clip 150 is shown to be placed in right ear hook attach cavity 158). Outer cover 26 is also preferably coupled to light pipe assembly 28, as shown. Light pipe assembly 28 preferably includes LED 20 soldered to LED PCB 24, which in turn is attached to light pipe 22, as shown. In a preferred embodiment, light pipe 22 provides the user with the status of headset 10.

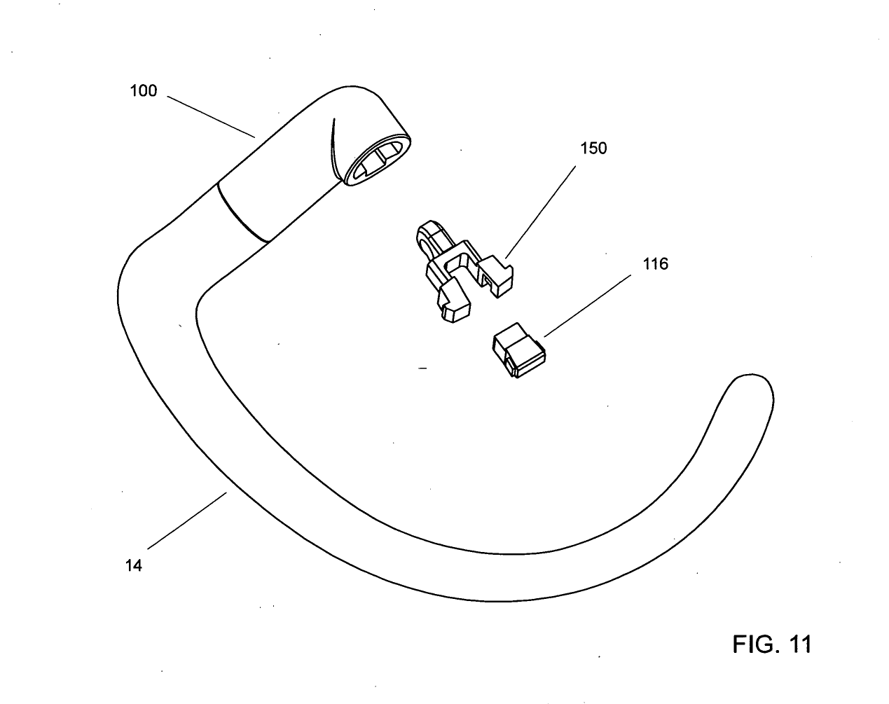

In FIG. 11, a schematic of an assembly detail of ear hook assembly 14 (shown here for a right ear) is provided. As illustrated, ear hook assembly 14 is preferably attached to attach hinge 100, which preferably attaches to attach clip 150 and rubber insert 116, as shown. During use, right ear hook 14 is captured in ear hook attach hinge 100 with an undercut and a friction fit, which allows ear hook 14 to rotate about ear hook attach hinge 100. As a result, a comfortable angle may be achieved between ear hook 14 and headset 10 when it is worn.

In a preferred embodiment, right ear hook attach clip 150 is molded out of acetal resin and is fastened to attach hinge 100 with a metal dowel (not shown), whereas ear hook 14 and ear hook attach hinge 100 are preferably injection-molded out of PC-ABS plastic. Ear hook attach clip 150 is also preferably designed so that there is a preload, i.e., the clip hooks are wider than the opening in the ear hook attach cavity 158 in cover 26. The elasticity of ear hook attach clip 150 in combination with the elasticity of an ear hook attach rubber insert 116 in compression (which is preferably molded out of Shore A eighty grade silicone rubber) provides the appropriate force to force open ear hook attach clip 150 so that its hooks are securely captured in ear hook attach cavity 158. Right ear hook assembly 14 and left ear hook assembly 22 fasten to headset 10 in the same way. A small elastomeric ear hook plug 142 (shown in FIG. 3) is then used to plug the un-used ear hook attach cavity 158.

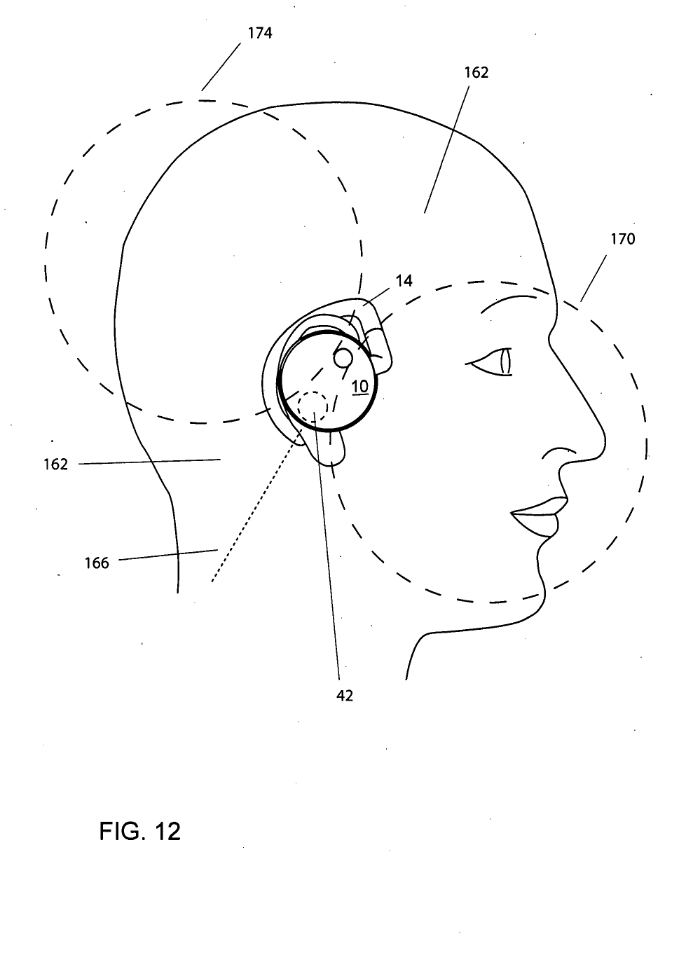

The operation of boomless, compact wireless headset 10 will now be described. Referring to FIG. 12, headset 10 is shown being worn on the user's right ear. In a preferred embodiment, calls are initiated and/or answered in the same way as using a typical Bluetooth headset. For example, a call may be answered by the user pressing answer button 10. The volume of the receive level may then be adjusted by pressing the respective side of volume button 18. Headset 10 may also be powered on or off by using sliding power button 34.

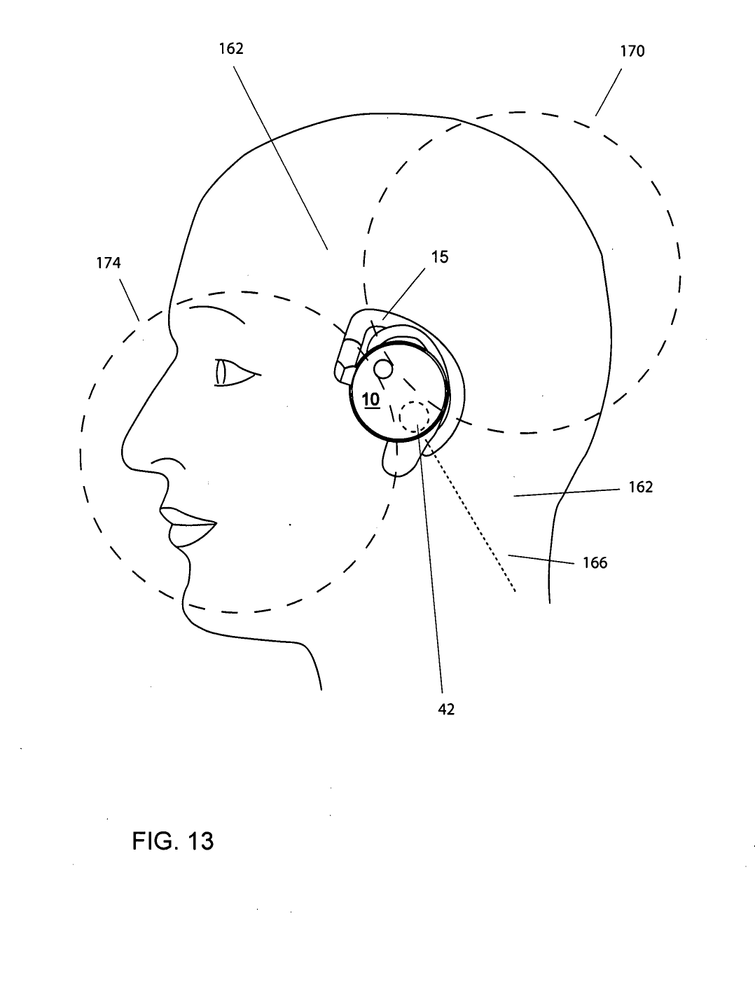

FIG. 12 shows that bi-directional microphone 62 preferably includes two sensitivity fields (i.e., three-dimensional zones of microphone sensitivity), sensitivity field A 170 and sensitivity field B 174. Bi-directional microphone sensitivity field A 170 and sensitivity field B 174 drop off in sensitivity according to the inverse square law. Sound that emanates substantially in one of sensitivity field A 170 or sensitivity field B 174 is picked up by microphone 62, amplified by microprocessor 86, and sent across a link (e.g., a Bluetooth link). Acoustic sound waves that hit both sensitivity field A 170 and sensitivity field B 174 substantially simultaneously are cancelled by bi-directional microphone 62, resulting in an area of low sensitivity. The areas of low microphone sensitivity in between sensitivity field A 170 and sensitivity field B 174 is referred to as a null 162 (i.e., a non-sensitivity field), as shown in FIG. 12 and FIG. 13. It should also be appreciated that bi-directional microphone 62 cancels out far field sound emanations. Bi-directional noise-cancelling microphones 62 are well known by those skilled in the art of headset design and the details of their function will not be described here.

In FIG. 12, sensitivity field A 170 covers the wearer's mouth, so sound emanating from the wearer's mouth is amplified. Although sound from rear sensitivity field B 174 is also amplified, due to the angle and placement of rear sensitivity field B 174, there is typically not substantial acoustic energy emanating within this field.

Since speaker 42 is located in null 162 of bi-directional microphone 62, sound that exits the headset 10 through the speaker port holes 126 is picked up by microphone 62 at as a lower signal strength, helping the echo cancelling function of the headset 10. In practice, the signal from speaker 42 has been shown to be as much as 10 dB lower when emanating from the null 162, compared to if this same signal was emanating at the same distance in sensitivity field A 170 or sensitivity field B 174.

Microprocessor 86 may also include an integral digital signal processor (hereafter DSP) that executes firmware, which cancels echo by extracting the receive signal emanating from speaker 42 and entering microphone 62 from the send signal in real time. Such echo canceling firmware is provided by Acoustic Technologies, Inc., of Mesa, Ariz. Within such embodiment, the microphone gain and speaker gain are all set in microprocessor firmware so that the headset 10 does not generate feedback.

In an exemplary embodiment, when a user talks, sensitivity field A 170 picks up the user's voice signal, amplifies it, and sends the amplified send signal to the mobile phone, where it is transmitted to the caller. Likewise, when the caller speaks, their voice is transmitted through the mobile cellular system to the mobile phone, where it is converted into Bluetooth packets and transmitted to the headset 10 where it is amplified and played through the speaker 42. The system is capable of full-duplex speech transmission, where both the caller and wearer can speak simultaneously and hear each other's speech simultaneously.

Referring now to FIG. 13, the headset 10 is worn on a user's left ear. Left ear hook assembly 15, a separate component that is a mirror image of right ear hook assembly 14, is used in place of right hear hook assembly 14 which is shown in FIG. 12. The headset 10 is functionally symmetrical about the axis of ambidexterity 166, shown in FIG. 12 and FIG. 13, as it is worn on either the right or left ear. In FIG. 13, sensitivity field B 174 is now receiving the user's speech signal, and sensitivity field A 170 is now in an area of low acoustic signal activity. Headset 10 is preferably designed so that in both the left and right wearing position, one of sensitivity field A 170 or sensitivity field B 174 is facing the user's mouth, and the speaker 42 is located in the null 162. Therefore, headset 10 includes a single integral microphone 62 that affords a small, balanced enclosure that can be worn on both the right and left ear. The circular shape of the housing of headset 10, coupled with the fact that no microphone boom is required, is thus a more aesthetically pleasing and stable (balanced) headset 10 for the user to wear.

It is to be understood that the present invention is not limited to the embodiment(s) described above and illustrated herein, but encompasses any and all variations falling within the scope of the appended claims. For example, although Bluetooth applications have been discussed here, one of ordinary skill in the art would appreciate that the present invention may be useful for several non-Bluetooth applications. One of ordinary skill in the art would also appreciate that two uni-directional microphones could be used in place of bi-directional microphone 62.

What is claimed is:

1. A wireless headset comprising:
an ear attachment coupled to the body of an open-air headset;
a transceiver;
a speaker;
a microprocessor; and
a directional microphone having a sensitivity field, wherein said sensitivity field is mutually exclusive from a non-sensitivity field, and wherein said speaker is placed in a region within said non-sensitivity field.

2. The headset of claim 1, wherein said microphone is a bidirectional microphone such that said sensitivity field includes a first and second sensitivity field.

3. The headset of claim 2, wherein said first and second sensitivity fields are symmetrically opposed to each other.

4. The headset of claim 1, wherein said microprocessor includes a digital signal processor (DSP).

5. The headset of claim 4, wherein said DSP executes firmware that performs a real-time extraction of a signal received into said headset from a signal transmitted out of said headset.

6. A wireless headset comprising:
an ear attachment coupled to the body of an open-air headset;
a transceiver;
a speaker;
a microprocessor; and
a bidirectional microphone having a first sensitivity field, a second sensitivity field, and a non-sensitivity field, wherein said first sensitivity field, said second sensitivity field, and said non-sensitivity field are each mutually exclusive from each other, and wherein said speaker is placed in a region within said non-sensitivity field.

7. The headset of claim 6, wherein said first and second sensitivity fields are symmetrically opposed to each other.

8. The headset of claim 6, wherein said ear attachment is an ear hook.

9. The headset of claim 6, wherein said microphone is coupled to a vibration shield.

10. The headset of claim 6, wherein said microprocessor is adaptable to a Bluetooth communications protocol.

11. An wireless headset comprising:
an ear hook coupled to the body of an open-air headset;
a transceiver;
a speaker;
a microprocessor comprising a digital signal processor (DSP); and
a directional microphone having a sensitivity field, wherein said sensitivity field is mutually exclusive from a non-sensitivity field, and wherein said speaker is placed in a region within said non-sensitivity field.

12. The headset of claim 11, wherein said microprocessor is adaptable to a Bluetooth communications protocol.

13. The headset of claim 11, wherein said DSP executes firmware that performs a real-time echo-cancellation procedure.

14. The headset of claim 11, wherein said microphone is a bidirectional microphone such that said sensitivity field includes a first and second sensitivity field.

15. The headset of claim 14, wherein said first and second sensitivity fields are symmetrically opposed to each other.

16. A method for routing a wireless signal comprising:
transmitting a signal from an audio gateway device to an open-air wireless headset;
receiving a signal from said headset into said audio gateway device, wherein said headset comprises;
an ear attachment;
a transceiver;
a speaker;
a microprocessor; and
a directional microphone having a sensitivity field, wherein said sensitivity field is mutually exclusive from a non-sensitivity field, and wherein said speaker is placed in a region within said non-sensitivity field.

17. The method of claim 16, wherein said microphone is a bidirectional microphone such that said sensitivity field includes a first and second sensitivity field.

18. The method of claim 17, wherein said first and second sensitivity fields are symmetrically opposed to each other.

19. The method of claim 16, wherein said microprocessor is adaptable to a Bluetooth communications protocol.

20. The method of claim 16, wherein said microprocessor includes a digital signal processor (DSP).

21. A system for routing a wireless signal comprising:
an audio gateway device; and
an open-air wireless headset, wherein said headset comprises;
an ear attachment;
a transceiver;
a speaker;
a microprocessor; and
a directional microphone having a sensitivity field, wherein said sensitivity field is mutually exclusive from a non-sensitivity field, and wherein said speaker is placed in a region within said non-sensitivity field.

22. The system of claim 21, wherein said microphone is a bidirectional microphone such that said sensitivity field includes a first and second sensitivity field.

23. The system of claim 22, wherein said first and second sensitivity fields are symmetrically opposed to each other.

24. The system of claim 21, wherein said microprocessor is adaptable to a Bluetooth communications protocol.

25. The system of claim 21, wherein said microprocessor includes a digital signal processor (DSP).
